(19) United States
(12) Patent Application Publication
(10) Pub. No.: US 2017/0268344 A1
(43) Pub. Date: Sep. 21, 2017

(54) LASER JOINING OF CMC STACKS

(71) Applicant: Siemens Energy, Inc., Orlando, FL (US)

(72) Inventors: Arindam Dasgupta, Avon, CT (US); Anand Kulkarni, Charlotte, NC (US); Ahmed Kamel, Orlando, FL (US)

(21) Appl. No.: 15/073,967

(22) Filed: Mar. 18, 2016

(51) Int. Cl. F01D 5/14; B32B 3/26; C04B 37/00; B32B 37/00; B32B 37/16; B32B 7/04; B32B 18/00

(52) U.S. Cl. CPC F01D 5/147; B32B 7/04; B32B 3/266; B32B 18/00; B32B 37/0076; B32B 37/16; C04B 37/005; F05D 2230/31; B32B 2315/02; B32B 2603/00; C04B 2237/04; C04B 2237/385; C04B 2237/78

(57) ABSTRACT

A method of manufacturing a gas turbine engine component (10) and the component so formed. The method includes: stacking a plurality of CMC layers (16) along a metal core (30) to form a stack of disconnected CMC layers, wherein adjacent edge faces (46) of the layers define a surface (44); additively depositing ceramic material (14) to only selected portions of the surface (44) to bond together at least some of the layers at their respective edge faces; and selecting locations for the depositing of the ceramic material to achieve a predetermined mechanical characteristic of the resulting component.

### FIELD OF THE INVENTION

The invention relates to gas turbine components formed by joining a stack of CMC layers, and more specifically, to a method of joining such CMC layers with a ceramic deposit additively deposited onto the stack.

### BACKGROUND OF THE INVENTION

Economics and environmental demands are driving the efficiency of combined cycle power plants with gas turbine engine topping cycles increasingly higher. In order to achieve this efficiency, the gas turbine cycle needs to operate at turbine inlet temperatures as high as 1600 to 1800 degrees Centigrade. At these temperatures, material operating limits are being reached and/or cooling flow requirements increase so much that the benefit of the higher inlet temperature is offset. One technique that has been used to address this challenge is to use ceramic matrix composite (CMC) materials for hot gas path surfaces such as a turbine vanes or blades, etc. An example of a suitable material class is oxide-oxide composites. Monolithic construction of such materials is problematic, and the use of CMC layers that are stacked to complete the component has been proposed. U.S. Pat. No. 7,247,003 to Burke at al. discloses such a structure. However, one challenge with such construction is that the CMC layers are not bonded, but instead they are bolted onto a metal backing. Very high heat loads on both the pressure and the suction side can lead to structural damage of the metal backing in this configuration. In addition to structural requirements, CMC stacks can pose an issue for overlay coating adherence, where the overlay coating may be, for example, a ceramic thermal barrier coating (TBC). Accordingly, there remains room in the art for improvement.

### BRIEF DESCRIPTION OF THE DRAWINGS

The invention is explained in the following description in view of the drawings that show:

FIG. 1 is a perspective illustration of an exemplary embodiment of a gas turbine component formed of a CMC stack and a ceramic deposit thereon.

FIG. 2 is a sectional view of the ceramic deposit of FIG. 1 along line 2-2 illustrated after an overlay coating has been added.

FIG. 3 is a perspective illustration of an alternate exemplary embodiment of a gas turbine component.

FIG. 4 is a schematic illustration of an interface between adjacent CMC layers.

FIG. 5 schematically illustrates a method of forming the ceramic deposit of FIG. 1.

### DETAILED DESCRIPTION OF THE INVENTION

The present inventors have devised an innovative CMC laminate structure that provides for improved structural integrity, improved sealing between layers, and improved adherence of any applied overlayer. The proposed structure includes a ceramic deposit additively formed on the CMC stack. The ceramic deposit may be applied such that it bonds at least two adjacent CMC layers to each other. It may also be deposited such that it forms a raised structure that will increase adherence of an overlayer. The ceramic deposit may be the only way the CMC layers are bonded together, and the ceramic deposit may form a gas tight seal so combustion gases do not pass between the CMC layers. Alternately, the CMC layers may also be bonded together and sealed using conventional means, such as with adhesive, such that an interface between adjacent CMC layers may be bonded and sealed using a combination of one or more ceramic deposits and adhesive. The inventors have also devised a method for applying the ceramic deposit using a laser beam to heat and melt ceramic powder to form the ceramic deposit via an additive manufacturing process.

It is known to melt an edge of a single CMC layer, as disclosed in U.S. Publication number 2007/0075455 to Marini et al. However, Marini discloses merely sealing a free edge of a single layer in order to improve wear resistance or hardness, and this results in a smooth coating/deposit. The method disclosed herein bonds plural CMC layers together along their adjoining edges with a ceramic deposit that may be rougher and therefore more suited for overlayer adherence than the smooth coating of Mariana. As used herein each CMC layer is a discrete structure prior to any bonding operation. That is to say that while each CMC layer may include resin material as part of its composition, abutting CMC layers are not bonded together by the matrix material that may be present within any individual CMC layer. Accordingly, while the CMC layer itself may be a laminate in that it may include fiber layers bonded together by a resin material, each CMC layer is considered a single, discrete CMC layer herein.

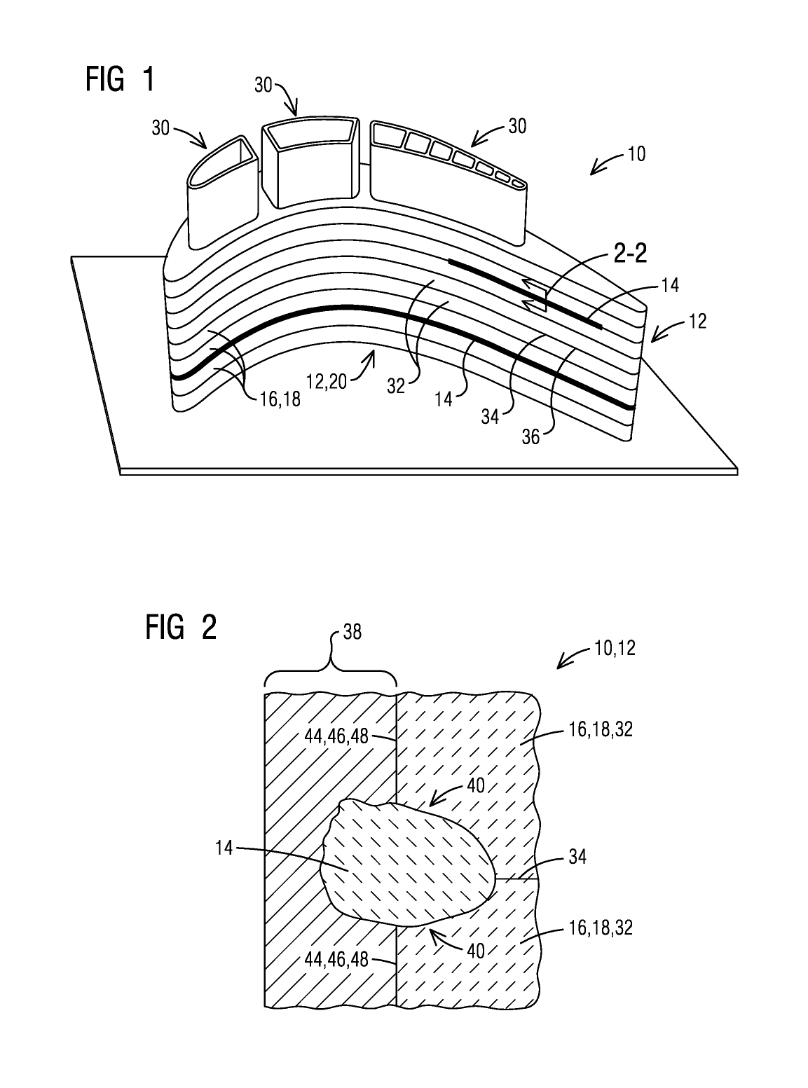

FIG. 1 is an illustration of an exemplary embodiment of a gas turbine component 10 formed of a CMC stack 12 and a ceramic deposit 14 thereon. The CMC stack 12 includes a plurality of CMC layers 16, such as an oxide-oxide composite. In this exemplary embodiment, each CMC layer 16 is in the form of a layer 18 of an airfoil portion 20 of the component 10, where the component 10 may be a gas turbine engine blade or vane. Also included is a metal core 30. In this exemplary embodiment the metal core 30 is partially hollow, with cavities that may function as cooling channels. In this configuration the CMC layers 16 of the CMC stack 12 protect the metal core 30 from combustion gases while the metal core 30 provides strength for the component 10. However, the disclosure is not meant to be limited to such a specific structure and the teaching may be applied more broadly as would be understood by those of ordinary skill in the art.

The ceramic deposit 14 is in the shape of a bead that bonds adjacent CMC layers 32 together, similar to an edge weld bead. The adjacent CMC layers 32 define an interface 34 there between (e.g. an area defined by faying surfaces) having a perimeter 36. A ceramic deposit 14 may extend along part of the perimeter 36 or it may extend along the entire perimeter 36. Various embodiments of the CMC stack 12 may include ceramic deposits 14 that extend along part of the perimeter 36, ceramic deposits 14 that extend along the entire perimeter 36, or a combination of the two. The selection of full or part extension of the ceramic deposit 14 and/or the use of adhesive between adjacent CMC layers 32 may be based on a desired/predetermined mechanical characteristic of the component 10 when complete. For example, partial edge bonding with a ceramic deposit 14 allows for some flexibility within the structure, whereas adhesive alone or adhesive and edge bonding may provide a stronger/less flexible structure. Any combination of edge bonding, adhesive and/or bolting may be used to achieve a desired mechanical characteristic in the component 10.

Moreover, the porosity of the ceramic deposit 14 may be controlled by controlling the deposition process to be from approximately forty percent to ninety percent to achieve a desired mechanical characteristic including, for example, permeability and rigidity. When formed as a non-permeable (gas-tight) ceramic deposit, and when formed between adjacent CMC layers 32, the ceramic deposit 14 seals the adjacent CMC layers 32 such that combustion gases cannot pass there between to reach the metal core 30. The porosity of the ceramic deposit 14 also controls the modulus of elasticity (rigidity) of the ceramic deposit 14. The strain tolerance of the ceramic deposit 14 is associated with the modulus of elasticity. Therefore, controlling the porosity can control the rigidity of the ceramic deposit as well as the strain tolerance. Accordingly, if a compliant bond (securement) between the adjacent CMC layers is desired, the ceramic deposit 14 may be made more porous. Alternately, if a rigid bond is preferred, the ceramic deposit 14 may be made less porous. The mechanical characteristics may be controlled such that they are uniform throughout the ceramic deposit 14, or so that they vary locally from one ceramic deposit 14 to another, or within a given ceramic deposit 14 as desired.

FIG. 2 is a sectional view of the ceramic deposit 14 of FIG. 1 along line 2-2, to which an overlayer 38 has been added. The ceramic deposit 14 forms a bead that joins corners 40 of the adjacent CMC layers 32, thereby forming a seal 42 there between that prevents combustion gases from passing through the interface 34. The ceramic deposit 14 is raised with respect to a surface 44 of the component 10 formed by edge faces 46 of respective CMC layers 16. Accordingly, in an exemplary embodiment, the ceramic deposit does not cover the entire edge face 46. If a ceramic deposit 14 is formed on both corners of one edge face 46, there may still be a remainder 48 of the edge face 46, and hence of the surface 44, that is not covered with the ceramic deposit 14. The elevated nature of the ceramic deposit 14 relative to surface 44 provides a greater surface area that increases adherence for the overlayer 38. The ceramic deposit 14 may also be shaped to include features that may better engage the overlayer 38, such as grooves, overhangs, etc. These, in turn, improve design life and spallation resistance of the overlayer 38.

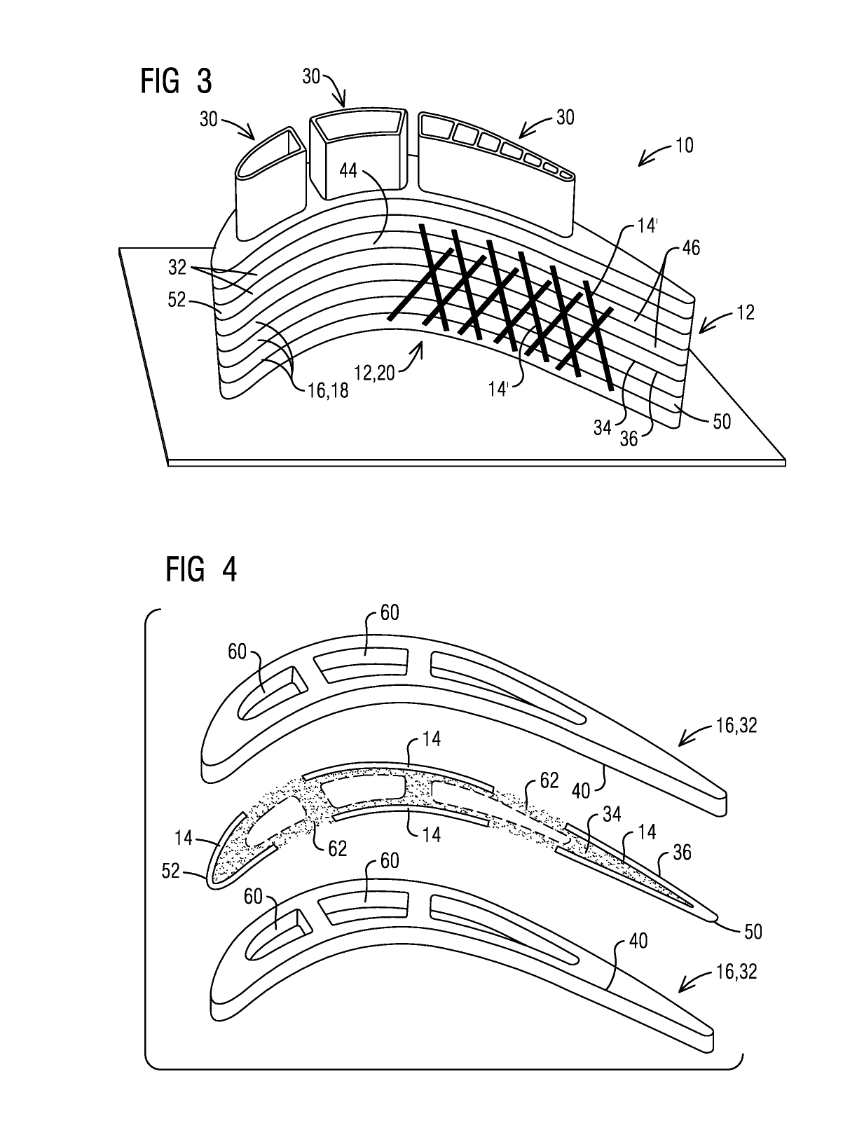

FIG. 3 is an illustration of an alternate exemplary embodiment where the ceramic deposit 14′ forms a pattern on the surface 44 of the component. The ceramic deposit 14′ is bonded to respective edge faces 46 of at least two adjacent CMC layers 32, and because it spans the respective interface 34, the ceramic deposit 14′ secures the adjacent CMC layers 32 to each other. As above, the mechanical characteristics can be controlled as desired within the pattern to produce predetermined mechanical characteristics. For example, toward a trailing edge 50, the ceramic deposit 14′ may be deposited to be denser, and hence more rigid, for structural integrity. Toward a leading edge 52, the ceramic deposit 14′ may be more porous and flexible, thereby increasing its ability to absorb impacts, thereby reducing foreign object damage (FOD). In another example, the ceramic deposit 14′ may be formed to be gas-tight, yet porous enough to permit minor deformation of the CMC stack 12 proximate the metal core 30, which provides the ultimate structural stability where present.

While a crisscross pattern is shown, any pattern may be used as will be understood by those of ordinary skill in the art. For example, beads of the pattern may be spaced closer together where greater overlayer adherence is sought. Likewise, a height, width, aspect ratio (e.g. 3:1 to 5:1 in terms of height/thickness to width), cross sectional shape, and surface roughness of the ceramic deposit 14, 14′ may also be controlled locally to achieve the balance of structural integrity, flexibility, and overlayer adherence sought.

FIG. 4 is a schematic illustration of adjacent CMC layers 32 and the interface 34 between the adjacent CMC layers 32. The interface 34 is defined by an area in between the adjacent CMC layers 32, akin to a faying area. Openings 60 in the CMC layers 16 receive the metal core 30 (not shown) and the interface 34 stands between combustion gases outside the CMC stack 12 and the openings 60. Therefore, the interface 34 may be sealed to prevent intrusion of the combustion gases between the CMC layers 16 so that the combustion gas does not reach the openings 60 and the metal core 30 therein. The seal may be achieved by forming the ceramic deposit 14 around the entire perimeter 36 of the interface 34. Alternately, the seal may be achieved by combining one or more ceramic deposits 14 with adhesive 62 in a manner that provides a continuous seal around the perimeter 36.

The adhesive 62 may permit little relative movement between the adjacent CMC layers 32 where applied. The ceramic deposit 14 secures the edges 40 of the adjacent CMC layers 32, but does not extend into the interface 34, and therefore may permit more relative movement between the adjacent CMC layers 32. Accordingly, the interface 34 can be tailored to control relative movement locally within each interface 34 depending on design requirements.

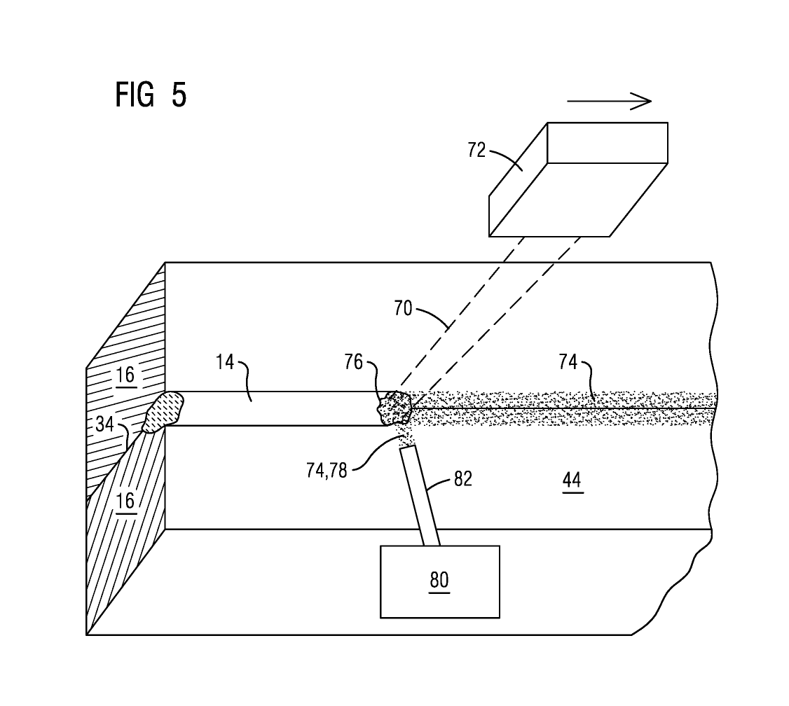

FIG. 5 schematically illustrates an exemplary embodiment of a method of forming the ceramic deposit 14, 14′, and in particular the ceramic deposit 14 of FIG. 1. In this exemplary embodiment, the ceramic deposit is formed by traversing an energy beam 70 emitted from an energy beam source 72, such as a laser, to melt ceramic material. The molten ceramic material then cools to form the ceramic deposit 14. The energy beam source 72 may be a green laser system with 512 nanometer wavelength and may generate a laser beam with a spot size of approximately fifty micrometers.

The process may be autogenous such that the ceramic that is melted is ceramic from the CMC layers 16. Alternately, or in addition, ceramic powder 74 may be used as filler and preplaced on the surface 44 where the ceramic deposit 14 is to be formed. The ceramic powder 74 may include particles from one (1) micron and above. Alternately, or in addition, the ceramic powder 74 may be fed to a process location 76 via a ceramic powder stream 78 delivered from a ceramic powder source 80 via a delivery tube 82. Other embodiments may use a paste, tape or ribbon to provide the ceramic filler material for the ceramic deposit. The ceramic to be melted, whether part of the CMC layers 16 or a separate filler material, may be semi or non-transparent to the selected energy beam 70 in order to capture the heat energy. Filler material may be provided with or without a binder material.

The process for forming the ceramic deposit 14 may be iterative. In such an exemplary embodiment, the ceramic deposit 14 may be built up in layers, where each layer is produced by melting ceramic in the manner disclosed above. Each layer may be from ten (10) microns thick to two (2) millimeters thick. The component 10 may be positioned in a bed of ceramic powder (not shown), a respective layer formed, the component lowered, and the next layer formed on the previously formed layer. Such a process would allow for one dimensional (1D) prints (ceramic deposit 14), two dimensional (2D) prints (ceramic deposit 14′), and three dimensional (3D) ceramic deposits, meaning that in the sectional view of FIG. 2, a cross-sectional shape of the ceramic deposit 14 could engineered as desired to better adhere the overlayer 38 to the CMC stack 12, such as with an overhang or undercut.

The innovative component and method proposed herein enables the manufacture of gas turbine components having improved structural integrity and overlayer adherence. These improvements can be tailored locally between adjacent CMC layers as well as locally in regions of the component spanning plural CMC layers, thereby increasing design flexibility. Accordingly, this represents a significant improvement in the art.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method of manufacturing a gas turbine engine component, the method comprising:
stacking a plurality of CMC layers along a metal core to form a stack of disconnected CMC layers, wherein adjacent edge faces of the plurality of CMC layers define a surface;
additively depositing ceramic material to only selected portions of the surface to bond together at least some of the plurality of CMC layers at their respective edge faces; and
selecting locations for the depositing of the ceramic material to achieve a predetermined mechanical characteristic of a resulting component.

2. The method of claim 1, further comprising;
applying adhesive between at least some of the plurality of CMC layers; and
selecting locations for applying the adhesive and for additively depositing the ceramic material to seal against intrusion of gas between adjacent CMC layers.

3. The method of claim 1, further comprising:
additively depositing the ceramic material to form a ceramic deposit extending above the surface; and
depositing an overlayer to the surface over the ceramic deposit.

4. The method of claim 1, further comprising additively depositing the ceramic material along an interface between adjacent edge faces of two of the plurality of CMC layers to form a seal there between.

5. The method of claim 1, further comprising controlling the step of additively depositing ceramic material to achieve a predetermined porosity of the ceramic material effective to contribute to the predetermined mechanical characteristic.

6. A gas turbine engine component formed by the method of claim 1.

7. A gas turbine engine vane formed by the method of claim 1, wherein the ceramic material is deposited proximate a trailing edge of the vane.

8. A method, comprising forming stacking CMC layers together, wherein each CMC layer is discrete, and forming a ceramic deposit such that the ceramic deposit bonds to at least two CMC layers and secures the at least two CMC layers together.

9. The method of claim 8, further comprising forming the ceramic deposit as a bead that joins corners of edge faces of abutting CMC layers, and forming the bead as a raised bead that is raised with respect to a remainder of the edge faces.

10. The method of claim 8, further comprising defining a surface using edge faces of abutting CMC layers, and forming the ceramic deposit as a pattern bonded to the surface, wherein the pattern secures the abutting CMC layers to each other by traversing an interface between the abutting CMC layers.

11. The method of claim 10, further comprising forming the pattern to be raised with respect to a remainder of the surface.

12. The method of claim 8, further comprising forming the ceramic deposit via an additive manufacturing process.

13. The method of claim 8, further comprising defining a surface using edge faces of abutting CMC layers, and depositing a thermal barrier coating onto the surface and on the ceramic deposit.

14. A gas turbine engine component, comprising:
a stack comprising at least two CMC layers, wherein adjacent CMC layers define an interface therebetween that is free of matrix material;
a ceramic deposit bonded to edges of the at least two CMC layers, wherein the ceramic deposit secures the at least two CMC layers to each other.

15. The gas turbine engine component of claim 14, wherein the edges define a surface, and wherein the ceramic deposit is raised relative to a remainder of the surface.

16. The gas turbine engine component of claim 14, wherein the interface defines a perimeter, and wherein the ceramic deposit forms a bead that seals the interface at the perimeter.

17. The gas turbine engine component of claim 14, wherein the interface is sealed to prevent combustion gases from entering the interface.

18. The gas turbine engine component of claim 14, wherein the edges define a surface, wherein the ceramic deposit defines a pattern bonded to the surface, wherein the pattern secures abutting CMC layers to each other.

19. The gas turbine engine component of claim 18, wherein the pattern is raised relative to a remainder of the surface.

20. The gas turbine engine component of claim 14, wherein the edges define a surface, the gas turbine engine component further comprising a thermal barrier coating on the surface and on the ceramic deposit.
